(19) United States
(12) Patent Application Publication
(10) Pub. No.: US 2005/0075820 A1
(43) Pub. Date: Apr. 7, 2005

(54) Method for checking test points of printed circuit board layout text data before plotting the printed circuit board layout map

(76) Inventors: Hsin-Chung Yang, Jhongli City (TW); Wei-Hung Huang, Taoyuan City (TW)

Correspondence Address: RABIN & Berdo, PC, 1101 14TH STREET, NW, SUITE 500, WASHINGTON, DC, 20005, US

(21) Appl. No.: 10/957,607

(22) Filed: Oct. 5, 2004

(30) Foreign Application Priority Data
Oct. 6, 2003 (TW) 92127720

(51) Int. Cl. G06F 19/00

(52) U.S. Cl. 702/117

(57) ABSTRACT

A method for checking test points of printed circuit board layout text data before plotting the printed circuit board layout map is disclosed. Firstly, providing a printed circuit board layout text data, which may be plotted as a printed circuit board layout map. Next, collecting the name data of a number of nodes from the layout text data. Subsequently, collecting the layout data of a number of useful test points from the layout text data. Then, analyzing the effectiveness of these useful test points for selecting a number of effective test points from these useful test points; Subsequently selecting a real test point of each of the nodes from these effective test points. Lastly, analyzing the distribution data of these nodes and the real test points.

This application claims the benefit of Taiwan application Serial No. 92127720, filed Oct. 6, 2003, the subject matter of which is incorporated herein by reference.

### BACKGROUND OF THE INVENTION

1. Field of the Invention

The invention relates in general to a method for checking test points of printed circuit board, and more particularly to a method for checking test points before plotting the printed circuit board layout map.

2. Description of the Related Art

Printed circuit board, whose main function is to provide a stable electric environment for the electric circuit connecting fixed electronic components and connected electronic components, is a key constituting element of an electronic device. According to the disposition of electric circuits, printed circuit boards can be classified as single-sided board, double-sided board and multi-layer board. The single-sided board uses an insulation substrate on which the metallic wires of the connected electronic components are disposed as a supporting body during the assembly of electronic components. In order to equip electronic devices with more diversified functions, more electronic components are needed and more complicated circuits are designed. Consequently, the single-sided board cannot meet the increasing needs of functions and is displaced by the double-sided board. A double-sided board has a number of electric through holes formed in an insulation substrate for electrically connecting with a number of electric circuits disposed on the upper surface and the bottom surface of the insulation substrate. Apart from that, a multi-layer board, which is used in a more complicated electric environment, has electric circuits pressed together and disposed in a multi-layer structure with electric through holes being formed in each layer for connecting the electric circuits disposed in each layer.

Referring to FIG. 1, a flowchart diagram of a conventional method of forming a printed circuit board. Firstly, in step 10: an electric circuit designer designs a circuit diagram of the electronic components. Next, proceed to step 11: a layout operator uses the printed circuit board layout software to perform the layout of the circuit diagram of the electronic components. At first, the layout map displayed on the computer screen may seem to be a bit messy; however; the layout operator may re-arrange these electronic components and circuits to make them in order. Then, proceed to step 12: the layout operator sight checks the layout map displayed on the computer screen, then uses the printed circuit board layout software to set the test points of the nodes in the layout map. A node is located on the connecting line between any two electronic components, of which, each node must be incorporated with a test point. Next, proceed to step 13, the layout operator inspects the distribution status of the test points in the layout map, and further checks whether each of the nodes connects with a test point or not. After that, proceed to step 14: the layout operator converts the finalized layout map into a layout text data and has the layout text data outputted. Of which, the layout text data include at least the name data of all nodes disposed on the printed circuit board, the layout data of all test points and that of all electronic components.

Next, proceed to step 15: a printed circuit board layout map is plotted from the layout text data by using a particular software and sent to a printed circuit board manufacturer. The printed circuit board layout map is in the form of a computer file, a Gerber file for instance. Then, proceed to step 16: the printed circuit board manufacturer prepares the needed materials and electronic components to manufacture the printed circuit board according to the plotted printed circuit board layout map. After that, proceed to step 17: the electric quality of the printed circuit board is tested by using an examining tool. The examining tool having a number of probes thereon is manufactured according to the layout text data, wherein these probes contact these test points disposed on the upper surface and the bottom surface of the printed circuit board for testing the electric qualities of the printed circuit board.

It is noteworthy that to sight check the distribution status of test points before plotting the printed circuit board map takes the layout operator a large amount of operation time. Moreover, the layout operator might easily neglect a test point due to negligence, which is a potential risk to the manufacturing of the printed circuit board, if the interval between these test points is smaller than the diameter of a probe or if these test points are covered by the electronic components and are not detected by the layout operator. This not only affects the electric quality and testability of a printed circuit board, but also increases the failure rate of the printed circuit board as well as the manufacturing time and manufacturing costs of examining tools.

### SUMMARY OF THE INVENTION

It is an object of the invention to provide a method for checking test points of printed circuit board layout text data before plotting the printed circuit board layout map, which checks the test points to discover the distribution status of all test points before the printed circuit board layout map is sent to the printed circuit board manufacturer. On one hand, the problems of the test points may be discovered beforehand and resolved earlier. On the other hand, the electric quality and testability of the printed circuit board are increased while the failure rate of the printed circuit board as well as the manufacturing time and manufacturing cost of the examining tool are reduced.

It is another object of the invention to provide a method for checking test points of printed circuit board layout text data before plotting the printed circuit board layout map. Firstly, providing a layout text data, which may be plotted as a printed circuit board layout map. Next, collecting the name data of a number of nodes from the layout text data. Subsequently, collecting the layout data of a number of useful test points from the layout text data. Then, analyzing the effectiveness of the useful test points for selecting a number of effective test points from these useful test points. Subsequently, selecting a real test point of each of the nodes from these effective test points. Lastly, analyzing the distribution data of these nodes and the real test points.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a flowchart diagram of a conventional method of forming a printed circuit board;

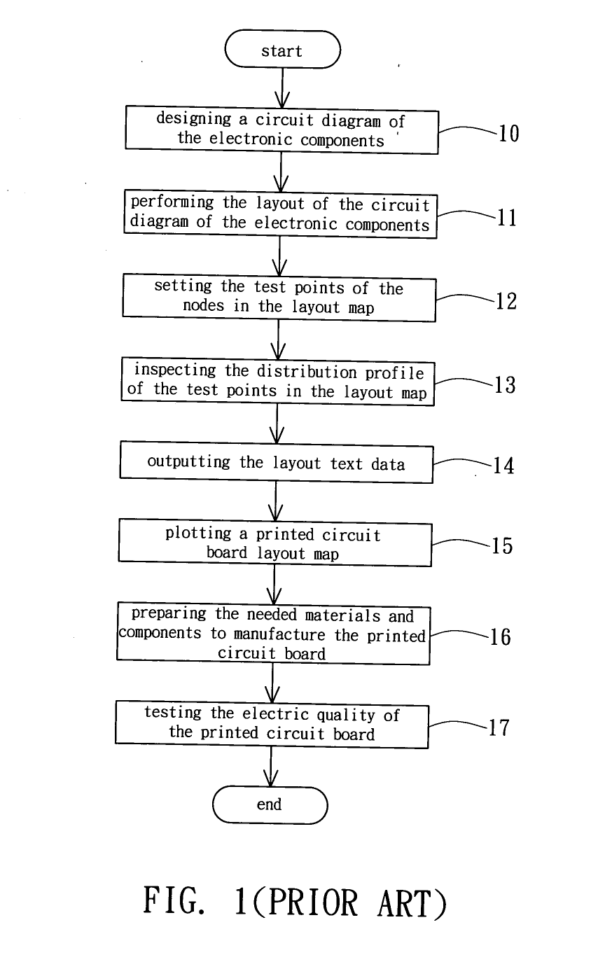

FIG. 2 is a flowchart diagram of a method according to preferred embodiment one of the invention for checking test points of printed circuit board layout text data before plotting the printed circuit board layout map; and

FIG. 3 is a flowchart diagram of a method according to preferred embodiment two of the invention for checking test points of printed circuit board layout text data before plotting the printed circuit board layout map.

### DETAILED DESCRIPTION OF THE INVENTION

Preferred Embodiment One:

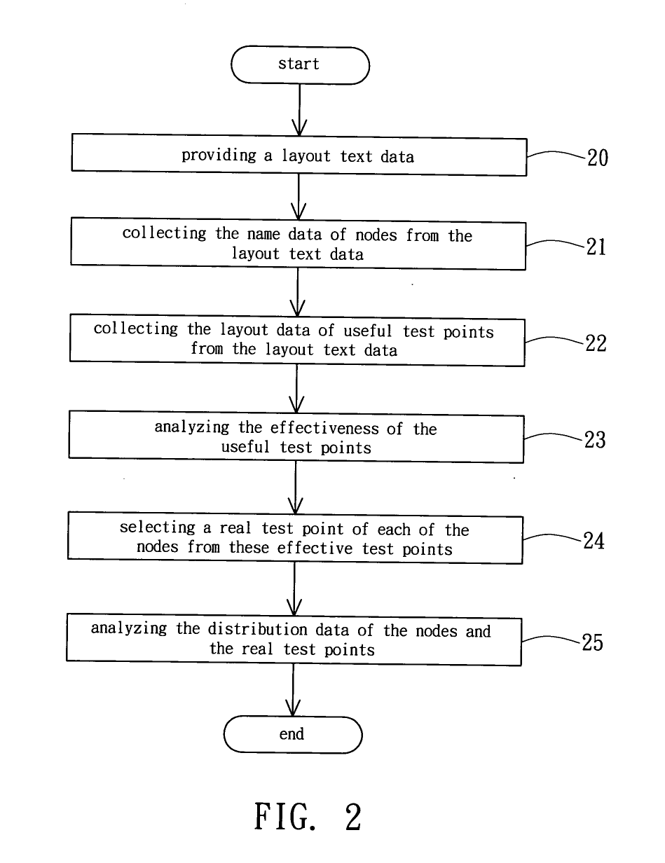

Referring to FIG. 2, a flowchart diagram of a method according to preferred embodiment one of the invention for checking test points of printed circuit board layout text data before plotting the printed circuit board layout map. Firstly, start with step 20: providing a layout text data, which may be plotted as a printed circuit board layout map. Next, proceed to step 21: collecting the name data of a number of nodes from the layout text data. Then, proceed to step 22: collecting the layout data of a number of useful test points from the layout text data. Of which, the layout data of these useful test points include the coordinate of each of these useful test points disposed on a printed circuit board, the name data of the nodes connected with each of the useful test points and the test point type of each of the useful test points. A test point may be in the form of a planar test point, a through hole or an electronic component lead.

After that, proceed to step 23: analyzing the effectiveness of these useful test points for selecting some effective test points from these useful test points. For example, based on the layout data of these useful test points, the effectiveness of a useful test point may be determined according to whether the interval between any two useful test points is smaller than a predetermined value or not. One of the two useful test points is selected as an effective test point if the interval is smaller than the predetermined value. The two useful test points are defined as two effective test points if the interval is larger than or equal to the predetermined value. Of which, the predetermined value may be the diameter of a probe of the examining tool used by those who are familiar with the technology of the invention, say, 50, 75 or 100 mils.

Following that, proceed to step 24: selecting a real test point of each of the nodes from these effective test points. For example, selecting a real test point of each of the nodes from these effective test points in the order of planar test point, through hole and electronic component lead. Lastly, proceed to step 25: analyzing the distribution data of the nodes and the real test points as shown in Table 1. The 96% testability in item (A) of Table 1 is obtained by having the number of these nodes with real test points divided by the number of these nodes. As shown in item (B) of Table 1, the distribution data of these nodes and real test points further include the distributed number and distribution ratio of these real test points disposed on both the a upper surface and a bottom surface of a printed circuit board. Of which, the distributed number of real test points disposed on the upper surface and the bottom surface is 74 and 278 respectively, while the distribution ratio of the real test points on the upper surface and bottom surface equals 20% and 80% respectively. Furthermore, the distribution data of these nodes and real test points further include the data of planar test points and through holes distributed on the upper surface and the bottom surface. As shown in item (C) of Table 1, the distribution data of these nodes and real test points further include the number of the nodes connecting with less than 2 electronic components, i.e., the number of the NC (Not Connected) points. The number of the NC points is 18 for instance.

As shown in item (D) of Table 1, the distribution data of these nodes and real test points further include the interval between these real test points and the specifications of appropriate probes. Of which, the 50-mil-diameter probe is appropriate for any two test points whose interval is between 50-75 mils; totally, the 50-mil-diameter probe is appropriate for 14 real test points disposed on the upper surface. The 75-mil-diameter probe is appropriate for any two test points whose interval is between 75-100 mils; totally, the 75-mil-diameter probe is appropriate for 9 real test points disposed on the upper surface. The 100-mil-diameter probe is appropriate for any two test points whose interval is over 100 mils; totally, the 100-mil-diameter probe is appropriate for 51 real test points disposed on the upper surface. The smaller the diameter a probe has, the higher the price will be. The invention reduces probe costs by using the specifications of appropriate probes according to the distribution data of the intervals between the real test points.

Moreover, the distribution data of these nodes and real test point further include a name data of these nodes without a real test point, i.e., the name data of these nodes without a real test point are omitted and not shown in Table 1.

When given the abovementioned distribution data of these nodes and real test points, the layout operator may edit the layout text data first then perform the checking method according to the invention again. By means of repetitive checking, the invention may reduce the negligence of omitting a test point to increase the testability of the printed circuit board.

TABLE 1
(A) Testability: 352/366 = 96%

| | |
|---|---|
| (B) Number of real test points on the | Upper surface ratio: |
| upper surface: 74 | 20% |
| Number of Planar test points on the | Number of through |
| upper surface: 74 | holes on the upper |
| | surface: 0 |
| Number of real test points on the | Bottom surface ratio: |
| bottom surface: 278 | 80% |
| Number of planar test points on the | Number of through |
| bottom surface: 263 | holes on the bottom |
| | surface: 15 |

(C) Number of nodes connecting with less than 2 electronic
components(NC points): 18

| | Specifications of appropriate | | |
|---|---|---|---|
| | probes | | |
| (D) | 50 (mil) | 75 (mil) | 100 (mil) |
| Number of real test points | 14 | 9 | 51 |
| on the upper surface | | | |
| Number of Real test points | 96 | 50 | 132 |
| on the bottom surface | | | |
| Number of the needed | 110 | 59 | 183 |
| Probes | | | |
| Ratio of the needed probes | 30 | 16 | 50 |
| (%) | | | |

Preferred Embodiment Two:

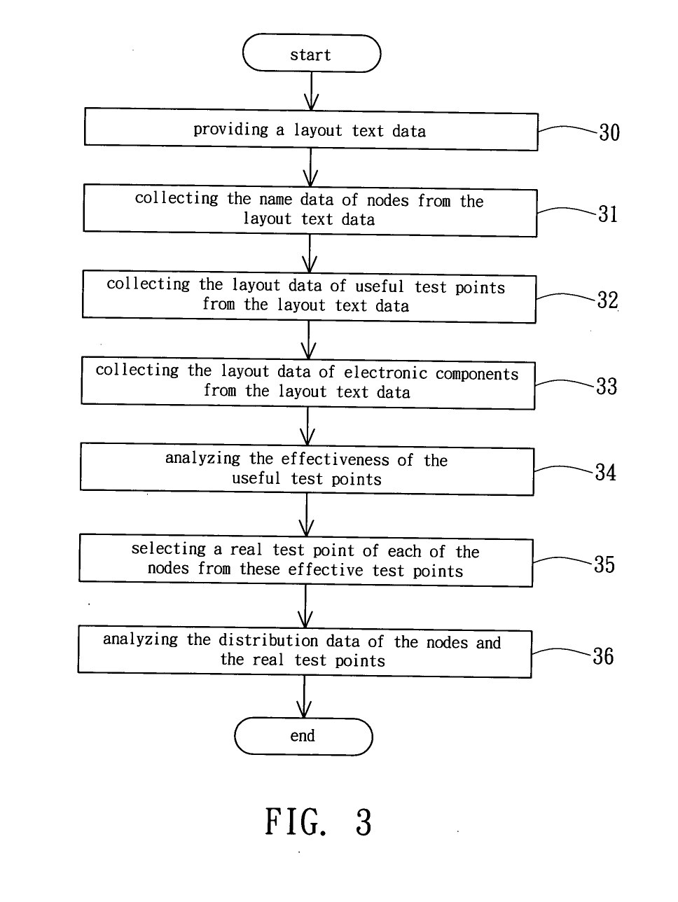

Referring to FIG. 3, a flowchart diagram of a method according to preferred embodiment two of the invention for checking test points of printed circuit board layout text data before plotting the printed circuit board layout map. Firstly, start with step 30: providing a layout text data, which may be plotted as a printed circuit board layout map. Next, proceed to step 31: collecting the name data of a number of nodes from the layout text data. Then, proceed to step 32: collecting the layout data of a number of useful test points from the layout text data. Of which, the layout data of these useful test points include the coordinate of each of the useful test points disposed on a printed circuit board, the name data of the node connected with each of the useful test points and the test point type of each of the useful test point. A test point may be in the type of a planar test point, a through hole or an electronic component lead. After that, proceed to step 33: collecting the layout data of a number of electronic components from the layout text data. Of which, the layout data of these electronic components include the coordinate of each of the electronic components disposed on the printed circuit board, the scale of each of the electronic components, the type of each of the electronic components and the name data of the node connected with each of the electronic components. Each of the electronic components may be in the form of a surface mount technology(SMT) type component or a pin through hole(PTH) type component.

Then, proceed to step 34: analyzing the effectiveness of these useful test points for selecting some effective test points from the useful test points. For example, based on the layout data of the useful test points that of the electronic components, the effectiveness of a useful test point may be determined according to whether a useful test point is pressed by the electronic components or not. A useful test point is defined as an ineffective test point if the useful test point is pressed by these electronic components. A useful test point is defined as an effective test point if not pressed by the electronic components.

Alternately, the effectiveness of a useful test point may be determined according to whether the interval between any two useful test points is smaller than a predetermined value or not. One of the two useful test points is selected as an effective test point if the interval is smaller than the predetermined value. The two useful test points are defined as two effective test points if the interval is larger than or equal to the predetermined value. Of which, the predetermined value may be the diameter of a probe of the examining tool used by those who are familiar with the technology of the invention, say, 50, 75 or 100 mils.

Besides, the invention may determine the effectiveness of a useful test point according to whether these useful test points are pressed by these electronic components first, then determine whether the interval between any two useful test points which are not pressed by these electronic components is smaller than a predetermined value or not afterwards. For example, first of all, determining whether these useful test points are pressed by these electronic components or not. A useful test point is defined as an ineffective test point if the useful test point is pressed by these electronic components. A useful test point is defined as a para-component test point if the useful test point is not pressed by these electronic components. Next, determining whether the interval between any two para-component test points is smaller than a pre-determined value or not. One of the two useful test points us elected as an effective test point if the interval is smaller than the predetermined value. The two para-component test points are defined as two effective test points if the interval is larger than or equal to the predetermined value.

The invention may alternately determine the effectiveness of a useful test point according to whether the interval between any two useful test points is smaller than a predetermined value first, then determine whether these useful test points are pressed by these electronic components or not afterwards. For example, first of all, determining whether the interval between any two useful test points is smaller than a predetermined value or not. One of the two useful test points is selected as a default test point if the interval is smaller than the predetermined value. The two useful test points are defined as two default test points if the interval is larger than or equal to the predetermined value. Next, determining whether these default test points are pressed by these electronic components or not. A default test point is defined as an ineffective test point if the default test point is pressed by these electronic components. A default test point is defined as an effective test point if the default test point is hot pressed by these electronic components.

After analyzing the effectiveness of these useful test points, proceed to step 35: selecting a real test point of each of the nodes from these effective test points. For example, selecting a real test point of each node from these effective test points in the type order of planar test point, through hole and electronic component lead. Then proceed to step 36: analyzing the distribution data of the nodes and the real test points.

Of which, the distribution data of these nodes and real test points include a testability obtained by having the number of these nodes with real test points divided by the number of these nodes, the distributed number and distribution ratio of these real test points disposed on both the front side and the rear side of a printed circuit board, the number of these nodes connecting less than 2 electronic components, the distribution data of the interval between any two of these real test points, the specifications of appropriate probes and the name data of these nodes without a real test point. The results are listed in Table 1 and are not repeated here.

The method for checking the test points of printed circuit board layout text data before plotting the printed circuit board layout map disclosed in the above preferred embodiments of the invention may examine the test points before the printed circuit board layout map is sent to the printed circuit board manufacturer's to obtain the distribution status of all test points beforehand. On one hand, the problems of the test points may be discovered beforehand and resolved earlier. On the other hand, the electric quality and testability of the printed circuit board are improved while the failure rate of the printed circuit board as well as the manufacturing time and manufacturing cost of the examining tool are reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method for checking test points of printed circuit board layout text data before plotting the printed circuit board layout map, comprising:
providing a layout text data, wherein the layout text data may be plotted as a printed circuit board layout map;
collecting the name data of a plurality of nodes from the layout text data;
collecting the layout data of a plurality of useful test points from the layout text data;
analyzing the effectiveness of the useful test points for selecting a plurality of effective test points from the useful test points;
selecting a real test point of each of the nodes from the effective test points; and
analyzing the distribution data of the nodes and the real test points.

2. The method according to claim 1, wherein the layout data of the useful test points comprise the coordinate of each of the useful test points disposed on a printed circuit board, the name data of the node connected with each of the useful test points and the test point type of each of the useful test point, the step of analyzing the effectiveness of the useful test points further comprises:
determining whether the interval between any two useful test points is smaller than a predetermined value or not;
selecting one of the two useful test points as an effective test point if the interval is smaller than the predetermined value; and
defining both of the two useful test points as two effective test points if the interval is larger than or equal to the predetermined value.

3. The method according to claim 2, wherein the predetermined value is 50 mils.

4. The method according to claim 1, wherein the step of selecting a real test point of each of the nodes from the effective test points further comprises:
selecting a real test point of each of the nodes from the effective test points in the type order of planar test point, through hole and electronic component lead.

5. The method according to claim 1, wherein the distribution data of the nodes and the real test points comprise a testability obtained by having the number of the nodes with the real test points divided by the number of the nodes.

6. The method according to claim 1, wherein the distribution data of the nodes and the real test points comprise the distributed number and the distribution ratio of the real test points disposed on a upper surface and a bottom surface of a printed circuit board.

7. The method according to claim 1, wherein the distribution data of the nodes and real the test points comprise the distribution data of the intervals between the real test points.

8. The method according to claim 1, wherein the distribution data of the nodes and the real test points comprise the name data of the nodes without a real test point and the specifications of appropriate probes.

9. A method for checking test points of printed circuit board layout text data before plotting the printed circuit board layout map, comprising:
providing a layout text data, wherein the layout text data may be plotted as a printed circuit board layout map;
collecting the name data of a plurality of nodes from the layout text data;
collecting the layout data of a plurality of useful test points from the layout text data;
collecting the layout data of a plurality of electronic components from the layout text data;
analyzing the effectiveness of the useful test points for selecting a plurality of effective test points from the useful test points;
selecting a real test point of each of the nodes from the effective test points; and
analyzing the distribution data of the nodes and the real test points.

10. The method according to claim 9, wherein the layout data of the useful test points comprise the coordinate of each of the useful test points disposed on a printed circuit board, the name data of the node connected with each of the useful test points and the test point type of each of the useful test points, the step of analyzing the effectiveness of the useful test points further comprises:
determining whether an interval between any two useful test points is smaller than a predetermined value or not;
selecting one of the two useful test points as an effective test point if the interval is smaller than the predetermined value; and
defining the two useful test points as two effective test points if the interval is larger than or equal to the predetermined value.

11. The method according to claim 9, wherein the layout data of the useful test points comprise the coordinate of each of the useful test points disposed on a printed circuit board, the name data of the node connected with each of the useful test points and the test point type of each of the useful test points, the layout data of the electronic components comprise the coordinate of each of the electronic components disposed on the printed circuit board, the scale of each of the electronic components, the type of each of the electronic components and the name data of the node connected with each of the electronic components, the step of analyzing the effectiveness of the useful test points further comprises:
determining whether the useful test points are pressed by the electronic components or not;
defining a useful test point as an ineffective test point if the useful test point is pressed by the electronic components; and
defining a useful test point as an effective test point if the useful test point is not pressed by the electronic components.

12. The method according to claim 9, wherein the layout data of the useful test points comprise the coordinate of each of the useful test points disposed on a printed circuit board, the name data of the node connected with each of the useful test points and the test point type of each of the useful test points, the layout data of the electronic components comprise the coordinate of each of the electronic components disposed on the printed circuit board, the scale of each of the electronic components, the type of each of the electronic components and the name data of the node connected with each of the electronic components, the step of analyzing the effectiveness of the useful test points further comprises:
determining whether the useful test points are pressed by the electronic components or not;
defining a useful test point as an ineffective test point if the useful test point is pressed by the electronic components;
defining a useful test point as a para-component test point if the useful test point is not pressed by the electronic components;
determining whether an interval between any two electronic components is smaller than a predetermined value or not;
selecting one of the two para-component test points as an effective test point if the interval is smaller than the predetermined value; and
defining the two para-component test points as two effective test points if the interval is larger than or equal to the predetermined value.

13. The method according to claim 9, wherein the layout data of the useful test points comprise the coordinate of each of the useful test points disposed on a printed circuit board, the name data of the node connected with each of the useful test points and the test point type of each of the useful test points, the layout data of the electronic components comprise the coordinate of each of the electronic components disposed on the printed circuit board, the scale of each of the electronic components, the type of each of the electronic components and the name data of the node connected with each of the electronic components, the step of analyzing the effectiveness of the useful test points further comprises:
determining whether an interval between any two useful test points is smaller than a predetermined value or not;
selecting one of the two useful test points as a default test point if the interval is smaller than the predetermined value; and
defining the two useful test points as two effective test points if the interval is larger than or equal to the predetermined value.
determining whether the useful test points are pressed by the electronic components or not;
defining a useful test point as an ineffective test point if the useful test point is pressed by the electronic components; and
defining a useful test point as an effective test point if the useful test point is not pressed by the electronic components.

14. The method according to claim 13, wherein the predetermined value is 50 mils.

15. The method according to claim 9, wherein the step of selecting a real test point of each of the nodes from the effective test points further comprises:
selecting a real test point of each of the nodes from the effective test points in the type order of planar test point, through hole and electronic component lead.

16. The method according to claim 9, wherein the distribution data of the nodes and the real test points comprise a testability obtained by having the number of the nodes with the real test points divided by the number of the nodes.

17. The method according to claim 9, wherein the distribution data of the nodes and the real test points comprise the distributed number and the distribution ratio of the real test points disposed on a upper surface and a bottom surface of a printed circuit board.

18. The method according to claim 9, wherein the distribution data of the nodes and the real test points comprise the distribution data of the intervals between the real test points.

19. The method according to claim 9, wherein the distribution data of the nodes and the real test points comprise the number of the nodes connecting with less than 2 electronic components.

20. The method according to claim 9, wherein the distribution data of the nodes and the real test points comprise the name data of the nodes without a real test point and the specifications of appropriate probes.
